(19) United States
(12) Patent Application Publication
(10) Pub. No.: US 2012/0191608 A1
(43) Pub. Date: Jul. 26, 2012

(54) Method and Apparatus for Regulating Electronic Mail Transmission through Funds Verification

(76) Inventors: Stewart Myers, Philomath, OR (US); Marina Myers, Grants Pass, OR (US)

(21) Appl. No.: 13/012,566

(22) Filed: Jan. 24, 2011

(51) Int. Cl. G06Q 40/00; G06F 15/16

(52) U.S. Cl. 705/44; 709/206

(57) ABSTRACT

Methods and apparatus for regulating the transmission of electronic mail message are provided. The amount of funds necessary to transmit the electronic mail message to its destination is calculated and the sender's account is queried to ensure sufficient funds exist. If so, the electronic mail message is sent to its destination and the amount of the funds are deducted from the sender's account. If not, the electronic mail message is held and the user is allowed to deposit sufficient funds to allow for delivery. In determining the necessary amount of funds, variables can include the geographic location of the destination and the size of the electronic mail message and its attachments.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to electronic mail (e-mail) and, more specifically, to an improved method and apparatus for regulating the transmission of e-mail based on verification of available funds for transmission.

2. Description of the Related Art

E-mail is the electronic evolution of traditional paper-based letters, notes, and memoranda. Modern e-mail is widely used to communicate between individuals worldwide. It can contain text, audio, video, or any combination thereof. Two of e-mail's advantages over paper-based communications include nearly instantaneous delivery time and relatively low cost. It is these advantages that have led to wide adoption in both the business and private sectors. Unfortunately, these advantages are having the two-fold effect of causing a decline in revenue for the United States Postal Service (USPS) and requiring greater expenditures on computer hardware in order to keep up with increasing e-mail demands. With e-mail use constantly on the rise, it is very likely that fees or charges will someday be imposed to offset the decline in USPS revenue and to help compensate e-mail providers for the cost of maintaining and improving electronic infrastructure. There is very strong need to charge for e-mails and to develop a method and apparatus for assessing whether an e-mail sender possesses sufficient funds to transmit an e-mail to its intended recipient.

Currently, e-mail users can send messages of varying size to anyone in the world for extremely low cost. Many services exist that provide free e-mail accounts to anyone with a computer and an internet connection. Not only can users send text-based communications, but they can send multimedia e-mails containing photographs, audio recordings, and even video as attachments or embedded directly in the e-mail message. These multimedia e-mails can be exponentially larger than text-based messages and can place much greater demands on network infrastructure. The bandwidth required to transmit multimedia e-mails and the storage space required to store them are much greater than for text-based messages. One e-mail containing video can consume as much hardware resources during transmission as hundreds or thousands of text-based e-mails. Despite the continued proliferation of multimedia e-mails, users can still send unlimited numbers of them nearly free of charge. With many other services it is traditional for people to pay in proportion to the amount of goods or services they consume. It is thus an object of a preferred embodiment of the present invention to meet the need of charging senders of e-mails proportionally to the size of the e-mail they send.

Unlike paper-based letters, e-mail messages can be sent to anyone anywhere in the world nearly instantaneously. Generally, users need only have an operational e-mail account, an e-mail client, and a connection to their e-mail server. Like paper-based letters, the greater the geographic distance between sender and receiver, the greater the number of resources needed to complete delivery. This is because e-mail messages are rarely transmitted directly from origination to destination. Instead, e-mails usually travel through one or more “hops” before reaching their destination. Hops are intermediate computers designed to receive, route, and forward messages onto the next hop or its final destination. Between each hop are connections that include copper wires, fiber optic cables, or wireless connections such as cell phone links or satellite signal relays. As the distance between sender and recipient increases, more of these connections are needed to communicate the message. When a message is sent intercontinentally, particularly between points that are separated by an ocean, that message travels along communication lines that are very expensive to construct and maintain. Contemporary e-mail messaging services do not require the sender to pay fees based on the geographic location of the recipient. It is thus an object of a preferred embodiment of the present invention to determine the relative geographic location of the recipient so that the amount of funds required to transmit the e-mail may be adjusted accordingly.

### BRIEF SUMMARY OF THE INVENTION

It is an object of the present invention to provide a method and apparatus for regulating the transmission of electronic messages based on verification of available funds for e-mail transmission.

It is another object of the present invention to provide a method and apparatus for determining the size of the e-mail message, including attachments, so that the amount of funds required to transmit the e-mail may be adjusted accordingly.

It is yet another object of the present invention to provide a method and apparatus for determining the geographic location of an e-mail so that the amount of funds required to transmit the e-mail may be adjusted accordingly.

In one exemplary embodiment of the present invention, e-mail messages are received at an e-mail server running Simple Mail Transfer Protocol (SMTP), extended SMTP (ESMTP), or any equivalent service intended for the transmission of e-mails across a computer network. The e-mail server may read the e-mail destination domain then send a request to a Domain Name Server (DNS), or equivalent service intended to assign domain names to numerical identifiers associated with networking equipment, for the purpose of locating and addressing computers, services, or any resource connected to a private network or the internet worldwide. The DNS server, or its equivalent, returns the location of the e-mail's destination to the e-mail server. Before being transmitted from the e-mail server to the first hop, or to the e-mail's destination, a funds calculation is performed to determine the amount required for transmitting the e-mail. An account containing the sender's available e-mail transmission funds is queried to see if the sender has sufficient funds for transmission. If the user has sufficient funds, the e-mail is transmitted from the e-mail server.

In another exemplary embodiment of the present invention, when e-mail is received at an e-mail server, the total message size, including attachments, is determined and may be used as part of the funds calculation. Messages would be assessed a size-based pro-rata amount before being sent to their destination.

In yet another exemplary embodiment of the present invention, the required funds calculation may include information about the recipient's geographic location. Determining the recipient's geographic location can be done through any number of methods including using DNS addresses, internet protocol (IP) addresses, or through any other protocol or service capable of providing geographic information about e-mail recipients. The greater the physical distance between the sender and recipient, the more resources the e-mail must make use of in order to reach its destination. Messages could be assessed a location-based amount that may be used in the calculation of the funds required to transmit the e-mail to its destination.

### BRIEF DESCRIPTION OF THE SEVERAL VIEWS OF THE DRAWING(S)

FIG. 1 is a block diagram of an exemplary internet network system with a method or apparatus for regulating the transmission of e-mails through funds verification as according to one embodiment of the invention;

FIG. 2 is a block diagram of an exemplary intranet network system with a method or apparatus for regulating the transmission of e-mails through funds verification as according to one embodiment of the invention;

FIG. 3 is a flowchart diagram of an exemplary method for regulating the transmission of e-mails through funds verification as according to one embodiment of the invention;

FIG. 4 is a block diagram of an exemplary processor-based apparatus that may be used to execute the exemplary machine readable instructions of FIG. 5;

FIG. 5 is a flowchart representative of exemplary machine readable instructions that may be used to regulate the transmission of e-mails through funds verification as according to one embodiment of the present invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system and apparatus include the discussed feature, advantage or mode of operation. The following description of the preferred embodiment is merely exemplary in nature and is in no way intended to limit the invention, its application, or uses.

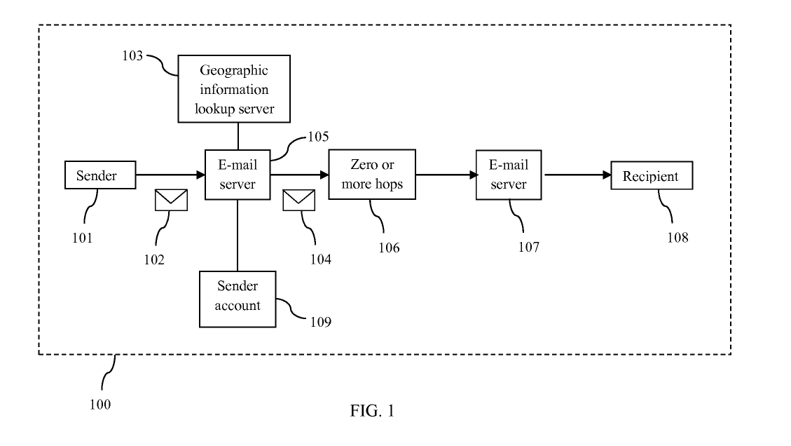

Referring now to FIG. 1, there is shown an exemplary internet network system 100 for regulating e-mail transmission through funds verification. An e-mail sender 101 and an e-mail recipient 108 may use any e-mail access device to access their e-mail accounts including, but not limited to, a web-enabled phone, a personal digital assistant, a laptop computer, a desktop computer, a terminal, a tablet computer, a web-based e-mail service, or any other medium configured to communicate with an e-mail server 105. When the sender 101 sends an e-mail 102 to the recipient 108, the e-mail 102 is first communicated to the e-mail server 105. The e-mail server 105 is configured to read destination information from the e-mail 102 and can send a request to a geographic information lookup server 103 to determine the recipient's 108 geographic location. The geographic information lookup server 103 can return the e-mail's 102 geographic location to the e-mail server 105. The geographic information lookup server 103 could be a domain name server, an IP lookup server, or any other device that associates geographic location with information retrieved from the e-mail 102.

The e-mail server 105 may be further configured to determine the size of the e-mail 102, including attachments, and may use that information, along with the geographic location information, to calculate the required funds for transmitting the e-mail 102 to its destination. Once the required funds have been calculated, the e-mail server 105 may query the e-mail sender's account 109 to determine whether sufficient funds exist for the e-mail's 102 transmittal. If the sender's account 109 contains sufficient funds, then the e-mail server 105 transmits the funded e-mail 104 through zero or more intermediate hops 106 to the e-mail recipient's e-mail server 107. If the sender's account 109 does not contain sufficient funds, the e-mail server 105 could send the e-mail sender 101 a notification message requesting they deposit additional funds. The intermediate hops 106 are usually e-mail relay servers designed to forward e-mail messages 104 along physical links between such servers until the message reaches the destination e-mail server 107. Once the e-mail message arrives at the recipient's e-mail server 107 the recipient 108 retrieves the e-mail 104 using any device or medium intended for communicating with an e-mail server.

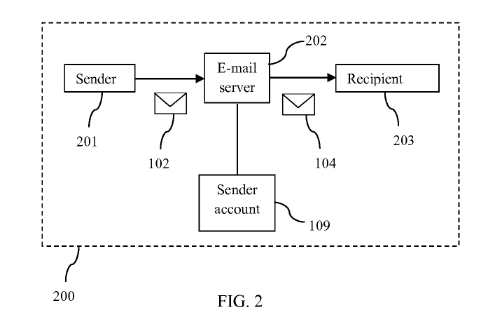

Referring now to FIG. 2 there is shown an exemplary intranet system 200 for regulating e-mail transmission through funds verification. An e-mail sender 201 and an e-mail recipient 203 may use any e-mail access device to access their e-mail accounts including, but not limited to, a web-enabled phone, a personal digital assistant, a laptop computer, a desktop computer, a terminal, a tablet computer, a web-based e-mail service, or any other medium configured to communicate with an intranet e-mail server 202. In the intranet system 200 the e-mail server 202 serves both the sender 201 and the recipient 203. When the sender 201 sends an e-mail 102 to the recipient 203, the e-mail 102 is first communicated to the e-mail server 202. The e-mail server 202 may be configured to read destination information from the e-mail 102. The e-mail server 202 may calculate the amount of funds required for delivering the e-mail 102 to the recipient 203. Once the amount of required funds have been calculated, the e-mail server 202 may query the sender's e-mail account 109 to determine whether sufficient funds exist for the e-mail's 102 delivery. If the sender's account 109 contains sufficient funds, then the e-mail server 202 may deliver the funded e-mail 104 to the recipient 203. If the sender's account 109 does not contain sufficient funds, the e-mail server 202 could send the e-mail sender 201 a notification message requesting they deposit additional funds.

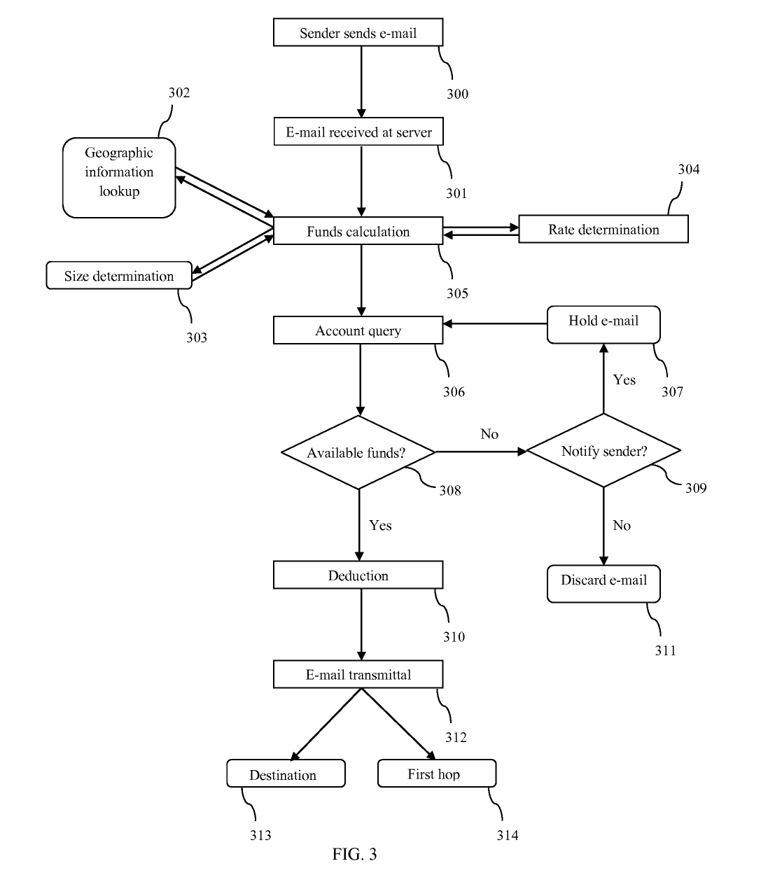

Referring now to FIG. 3 there is shown a flowchart diagram of an exemplary method for regulating the transmission of e-mails through funds verification. An e-mail sender 300 sends an e-mail to a recipient and that e-mail is received at an e-mail server 301. The e-mail server may be configured to read destination information from the e-mail and may use that information in calculating the amount of funds required 305 for transmittal of the e-mail. One component of the payment calculation 305 could be to lookup the geographic information 302 related to the e-mail's destination and to adjust the payment amount accordingly. Another component of the payment calculation could be to determine the size of the e-mail and its attachments 303 and adjust the payment amount accordingly. Yet another component of the payment calculation could be to determine what rate 304 applies to the e-mail and to adjust the amount of required funds accordingly.

After the required funds calculation 305 has been performed, the sender's funds account is queried 306 to determine whether sufficient funds exist for transmission of the e-mail. If available funds 308 do not exist, the sender may be notified 309 of the deficiency. If the sender is not notified 309 then the e-mail may be discarded 311. If the sender is notified 309 the e-mail could be held 307 for a time period sufficient enough to allow the sender to deposit sufficient funds into their funds account. After the time period for holding the e-mail has expired the sender's funds account could be queried 306 to determine if sufficient funds have been deposited. The steps of notifying the sender 309, holding the e-mail 307 and querying the funds account 306 could be repeated for as many times as permitted by system policies. The system policies could provide for a set number of notification cycles for all users, or could specify a variable number of notification cycles for different users.

Once the available fund determination 308 has been made, the amount of the required funds could be deducted 310 from the sender's funds account.

The e-mail server may then transmit 312 the e-mail to its final destination 313 or to a first hop 314. The e-mail's final destination can include another e-mail server, an e-mail client, an e-mail box, or any device or medium intended for the communication of the e-mail to the e-mail recipient. Hops, as referred to in this FIG. 3, are generally other e-mail servers linked by physical connections that relay or forward e-mails to their destinations. Since the sender's e-mail server and the recipient's e-mail server are rarely directly connected, especially in the context of internet-based e-mail systems, it is necessary for intermediate hops to route and forward e-mails along network infrastructure until they reach their destination.

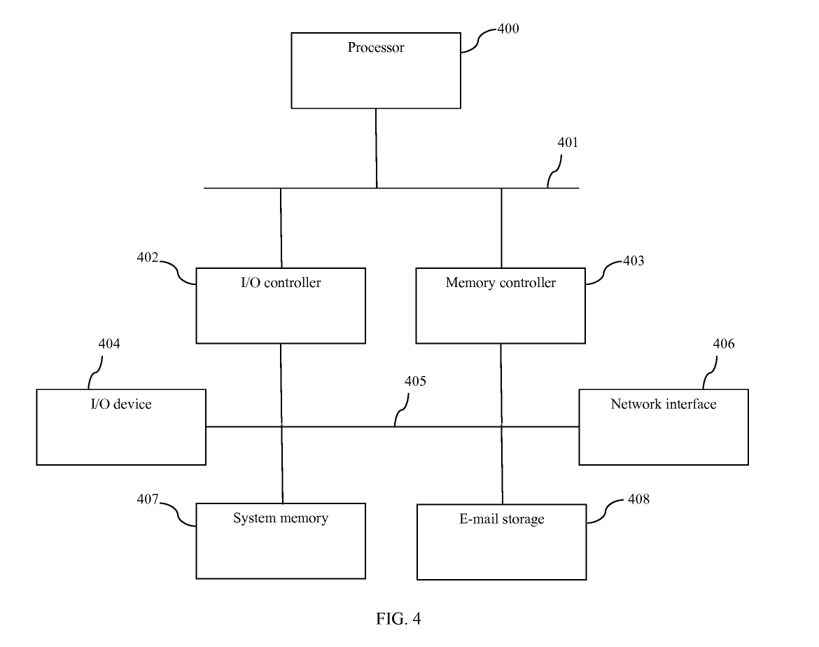

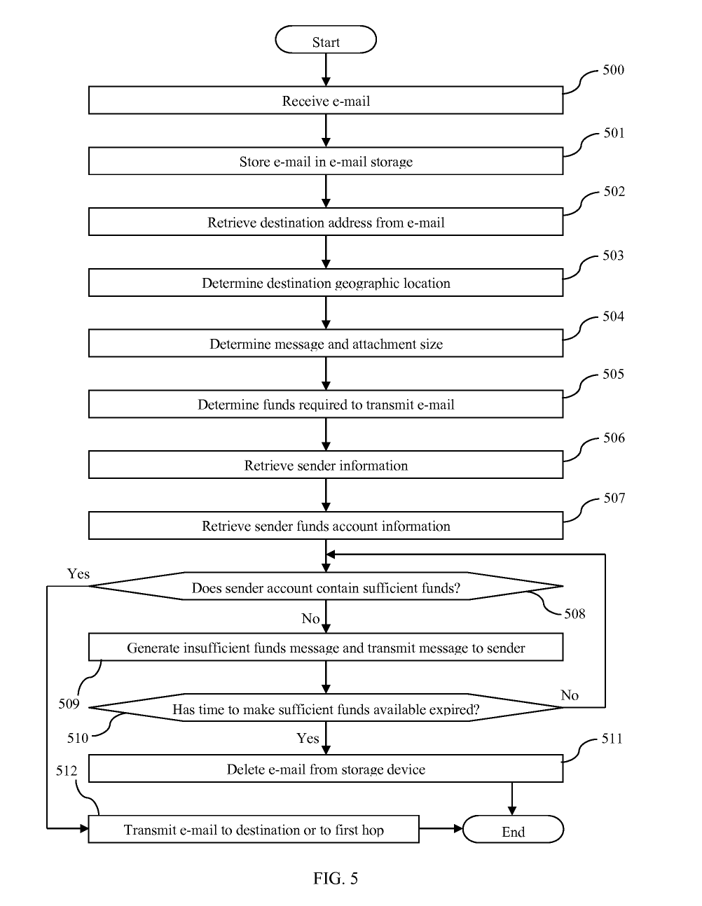

Referring now to FIG. 4, there is shown a block diagram of an exemplary processor-based apparatus for regulating the transmission of e-mails through funds verification that may be used to execute the exemplary machine readable instructions of FIG. 5. In the illustrated example, the example process-based apparatus is implemented using an e-mail server 105 (FIG. 1), 202 (FIG. 2). The example processor-based apparatus may alternatively be implemented in a manner that is separate from an e-mail server 105, 202. The example processor-based apparatus may be implemented in hardware, software, or any desired combination thereof. Each block of the example processor-based apparatus may be implemented using instructions, code, or other software or hardware implementations stored on a machine accessible medium that, when communicatively coupled with the other blocks of the exemplary processor-based apparatus, execute the exemplary machine readable instructions of FIG. 5.

The exemplary processor-based apparatus includes a processor 400 that is connected to a system bus 401. The processor 400 may be any central processing unit, general processing unit, or any other suitable processing unit that is capable of executing the exemplary machine readable instructions of FIG. 5. The processor 400 may also be a single processor, multiple processors or a processor with multiple cores that are connected to the system bus 401.

The processor 400 is communicatively coupled, by way of the system bus 401, to an input/output (I/O) controller 402 that performs functions to enable the processor 400 to access an I/O device 404 and a network interface 406. The I/O device 404 allows the processor 400 to interface with any desirable peripheral devices including keyboards, monitors, a computer mouse, printers, etc. The network interface 406 allows the processor to communicate with other processor-based devices or systems and may be a cable modem, digital subscriber line modem, Ethernet device, wireless network device, cellular modem, etc.

The processor 400 is also communicatively coupled, by way of the system bus 401 to a memory controller 403 that performs functions to enable the processor 400 to access system memory 407 and e-mail storage 408. The I/O controller 402 is communicatively coupled to the I/O device 404 and the network interface 406 by way of a second system bus 405. The memory controller 403 is communicatively coupled to the system memory 407 and the e-mail storage 408 by way of the second system bus 405.

The system memory 407 may be any type of random access memory, read only memory, dynamic random access memory, static random access memory, flash memory, volatile or non-volatile memory, or any other memory used in a processor-based device. The e-mail storage 408 may be any mass storage memory including hard disks, flash drives, solid-state drives, optical drives, tape storage, or any other memory used to store e-mail messages.

Referring now to FIG. 5, there is shown a flowchart representative of exemplary machine readable instructions that may be used to regulate the transmission of e-mails through funds verification. The instruction set may begin after any action resulting in an e-mail server 105 (FIG. 1) and 202 (FIG. 2) receiving an e-mail 500. The e-mail 102 (FIGS. 1 and 2) may be stored in an e-mail storage device 501 and the destination address may retrieved from the e-mail 502. Once the destination address has been retrieved 502, the geographic location information may be determined 503 by using relevant information contained within the e-mail. The relevant information can include an IP address, a DNS address or any other information that allows for the identification of the e-mail's geographic destination.

After the geographic location information is determined 503, the size of the e-mail, including its attachments may be determined 504. The size of the e-mail and its attachments 504 could be used with the geographic location information to calculate the funds required to transmit the e-mail to its destination 505.

The identity of the sender may be retrieved from the e-mail 506 and the sender's e-mail account may be queried 507 to determine if it contains sufficient funds 508 for delivery of the e-mail message. If the account contains sufficient funds, the e-mail message may be transmitted from the e-mail server on to its final destination or to a first hop 512 and the instruction set ends. If the sender's account does not contain sufficient funds, the e-mail server could generate an insufficient funds message and transmit the message to the sender 509. If the time to make sufficient funds available in the sender's account has not expired 510, the e-mail server could hold the message and re-query the sender's account to determine if sufficient funds have been made available. If the time to make sufficient funds available has expired, the e-mail server could delete the e-mail from the e-mail storage device 511 and the instruction set ends.

Of course, persons of ordinary skill in the art will recognize that the order, size, and proportions of the memory illustrated in the example systems may vary. Additionally, although this patent discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for regulating the transmission of electronic mail messages comprising the steps of:
receiving an electronic mail message at a server;
performing a calculation to determine an amount of funds required for transmitting the electronic mail message to its destination;
querying a funds account of the electronic mail message's sender to determine whether sufficient funds exist to transmit the electronic mail message;
deducting the amount necessary for transmitting the electronic mail message from the sender's funds account; and
transmitting the electronic mail message to a first hop or to its final destination.

2. The method of claim 1, further comprising the step of not transmitting the electronic mail message from the server if there are insufficient funds in the sender's funds account.

3. The method of claim 1, further comprising the step of notifying the sender if there are insufficient funds in the sender's funds account.

4. The method of claim 1, further comprising delaying transmission of the electronic mail message until the sender has deposited sufficient funds in the sender's funds account.

5. The method of claim 1, further comprising notifying the sender if transmission from the server to a first hop or to the electronic mail message's destination failed due to insufficient funds.

6. The method of claim 1, wherein performing a calculation includes using information about the geographic location of the electronic mail message's destination to determine the required funds.

7. The method of claim 1, wherein performing a calculation includes using the size of the electronic mail message and its attachments to determine the amount of required funds.

8. The method of claim 1, wherein sufficient funds means an amount of funds equal or greater to the amount of required funds for transmitting the electronic mail message to its destination.

9. The method of claim 1, wherein the sender's funds account represents monetary value.

10. An apparatus comprising:
a storage medium in which electronic mail messages are stored;
a processor that calculates the amount of funds necessary for transmitting the electronic mail messages to their destination;
a funds verification mechanism that verifies the electronic mail message's sender has an account with sufficient funds to transmit the electronic mail message to its destination; and
a transmission mechanism that transmits the electronic mail message on to a first hop or to its final destination upon verification of available funds.

11. The apparatus of claim 10, wherein the processor is capable of using information about the geographic location the electronic mail message's destination to calculate the necessary funds.

12. The apparatus of claim 10, wherein the processor is capable of using information about the size of the electronic mail message and all attachments to calculate the necessary funds.

13. The apparatus of claim 10, further comprising an automated response generator that sends a message to the electronic mail message sender if the sender has insufficient funds in the funds account or if transmission of the electronic mail message was not successful due to insufficient funds.

14. A method comprising:
receiving an electronic mail message;
retrieving information necessary for calculating the amount of funds necessary to deliver the electronic mail message to its destination;
determining the amount of funds necessary to deliver the electronic mail message to its destination;
determining if the electronic mail message's sender has posted sufficient funds to a funds account; and
transmitting the electronic mail message to its destination if the sender has sufficient funds for transmission in the funds account.

15. The method of claim 14, further comprising the step of delaying delivery of the electronic mail message until the sender has deposited sufficient funds in the funds account.

16. The method of claim 14, further comprising notifying the sender if delivery of the electronic mail message to its destination had failed due to insufficient funds.

17. The method of claim 14, wherein geographic information about the electronic mail message's destination is used in determining the necessary funds amount.

18. The method of claim 14, wherein the size of the electronic mail message and its attachments are used in determining the necessary funds amount.

19. The method of claim 14, wherein sufficient funds means an amount of funds equal or greater to the required funds for transmitting the electronic mail message to its destination.

20. The method of claim 14, wherein the funds represent a monetary value.
